(19) United States
(12) Patent Application Publication
(10) Pub. No.: US 2015/0176715 A1
(43) Pub. Date: Jun. 25, 2015

(54) ONE-WAY VALVE ASSEMBLY

(71) Applicants: Ying-Che HUANG, Changhua County (TW); Chun-Ming HUANG, Changhua County (TW)

(72) Inventors: Ying-Che HUANG, Changhua County (TW); Chun-Ming HUANG, Changhua County (TW)

(21) Appl. No.: 14/140,233

(22) Filed: Dec. 24, 2013

(51) Int. Cl. F16K 15/02

(52) U.S. Cl. CPC F16K 15/02

(57) ABSTRACT

A one-way valve assembly is provided in the present invention, including a central member, a valve seat, a valve plate and a plug member. The central member includes a first inner compartment and a first through hole. The valve seat includes a second inner compartment and a second through hole. A plurality of recesses are formed on the bottom surface of the second inner compartment, so the second through hole is spaced apart from the bottom surface of the second inner compartment. The valve seat is seated inside the first inner compartment. The valve plate is seated inside the second inner compartment of the valve seat. The plug member includes a third through hole, and is seated inside the first inner compartment of the central member so the valve seat and the valve plate are restricted in the first inner compartment between the plug member and the central member.

### BACKGROUND OF THE INVENTION

1. Field of the Invention

The present invention relates to a valve assembly, more particularly, relates to a valve assembly that can be utilized in an air transmitting device such as an inflator or a suction device.

2. The Prior Arts

The one-way valve is a type of valve component commonly used in an inflator or a suction device. The purpose of the one-way valve is to prevent the back flow of the air after the air has passed through the valve. A typical inflator usually includes a tubular body, a head member disposed at the tubular body, an air nozzle connected to the head member, and a piston and a piston rod disposed inside the tubular body. The one-way valve is disposed at the piston or the head member. After the air nozzle is connected with the nozzle of the object to be inflated, one can operate the piston rod and the tubular body so the air inside the tubular body is compressed by the piston. The compressed air is then pushed through the one-way valve into the object to be inflated via the head member and an air pipe.

In the inflator disclosed by the U.S. Pat. No. 8,007,258 or German Patent Number 102007021618, the one-way valve assembly is consisted of a piston member and a check valve. When the tubular body of the inflator moves in a direction away from the head member relevant to the air pump rod, air enters the tubular body from the vent hole of the upper lid into the bottom portion of the tubular body via the through hole of the piston member. When the tubular body moves toward the head member relevant to the air pump rod, the air at the bottom of the tubular body then enters the air passage of the air pump rod via the center hole and the check valve, and further exits from the head member and the air nozzle.

The check valve described above includes a check valve seat and a check valve plate. The check valve seat is a step-shaped cylinder, wherein an end of the check valve seat is inserted into the air passage at a second end of the air pump rod, and another end of the check valve seat is inserted into the piston member. The check valve plate is seated inside the check valve seat, and can move freely between the center hole of the piston member and the central hole of the check valve seat.

However, the structure of such conventional check valve is rather complicated. The check valve plate is not stable upon contact with the check valve seat, thereby causing the force to be unbalanced during the operation of the inflator. As a result, the non-return effect of the check valve is reduced, and the air flow during the pumping process is not smooth as well. In addition, due to the step-shaped design of the check valve seat and an end of the check valve seat being installed inside the air passage of the air pump rod, an end face at the front end of the check valve seat is not able to stay in close contact with the opposite surface, thereby causing air leakage.

Due to the design flaws in its structure, the usage of the conventional valve seat is limited. The conventional valve seat can only be used in an inflator, and cannot be used in a suction device. Hence, with the structure of the current valve seat, it is impossible to provide the function needed for an inflator and suction device in the same structure. Due to the above reasons, there is an urgent need for the industry to develop a valve seat, which can be used in an inflator and a suction device so as to lower the cost of production.

### SUMMARY OF THE INVENTION

Based on the above reasons, a primary objective of the present invention is to provide a one-way valve which solves the problems of reduced non-return effect, unsmooth air flow and air leakage of the conventional one-way valve due to its complex structure.

Another objective of the present invention is to provide a one-way valve, which can be used in a pumping device such as an inflator, or can be used in a suction device. In this way, the production cost can be lowered.

The present invention is characterized in that a valve seat assembled with a valve plate is disposed in a first inner compartment of a central member. The valve plate is disposed inside a second inner compartment of the valve seat. A second through hole and a plurality of recesses are disposed at the bottom of the second inner compartment of the valve seat, so the second through hole is spaced apart from the bottom surface of the second inner compartment with a distance. After the valve plate is seated inside the second inner compartment of the valve seat, the valve plate and the valve seat together are assembled inside a first inner compartment of the central member with a plug member in such manner that the valve plate and valve seat are restricted between the plug member and the bottom portion of the first compartment. In this way, the valve seat and the valve plate are able to achieve the non-return effect, and at the same time are able to prevent air leakage. In addition, the user can simply change the direction of the valve seat inside the first inner compartment to switch the direction of the airflow, so as to provide the function needed for an inflator or a suction device. In this way, the present invention is adapted to be used with an inflator or a suction device.

In order to fulfill the above objectives, a one-way valve assembly is provided in the present invention. The one-way valve assembly includes a central member, a valve seat, a valve plate and a plug member. The central member is provided with a first bottom portion having a flat bottom surface. A first sidewall is formed on the periphery of the first bottom portion extending in a side of an axial direction thereof, and a first inner compartment is formed by the first sidewall together with the first bottom portion. At least one first through hole is disposed through the first bottom portion. The valve seat includes a second bottom portion. A second sidewall is formed on the periphery of the second bottom portion extending in a side of an axial direction thereof, and a second inner compartment is formed by the second sidewall together with the second bottom portion. At least one second through hole is disposed through the second bottom portion. A plurality of recesses is formed on a surface facing the second inner compartment of the second bottom portion, so the second through hole is spaced apart from the surface of the second bottom portion with a distance. The valve seat is seated in the first compartment of the central member. The valve plate has an outer diameter smaller than an inner diameter of the second inner compartment of the valve seat while larger than an inner diameter of the second through hole. In addition, a thickness of the valve plate is smaller than a depth of the second inner compartment. The valve plate is seated in the second compartment of the valve seat in such way that the valve plate can move freely in the second inner compartment. The plug member is provided with a third through hole. The plug member is seated in the first inner compartment in such way that the valve seat and the valve plate are restricted in the first inner compartment between the first bottom portion and the plug member.

The central member for receiving the valve seat and the valve plate in the present invention can be a type of piston used in an inflator or a suction device.

Alternatively, the central member can also be a head member or other components used in an inflator or a suction device.

According to an embodiment of the present invention, when the central member is a type of piston in an inflator or a suction device, a female thread can be disposed at the first inner compartment of the central member. The female thread can be used to engage with a male thread disposed at a piston rod, so the piston is connected with the piston rod.

According to an embodiment of the present invention, when the central member is a head member of an inflator or a suction device, a female thread can be disposed at the first inner compartment of the central member, and a corresponding male thread can be disposed at the plug member. After the male thread of the plug member is engaged with the female thread of the first inner compartment of the central member, the valve seat and the valve plate are restricted in the first inner compartment between the plug member and the first bottom portion of the central member. The valve plate is still able to move freely inside the second inner compartment.

With the simplified structure of the valve seat and the first inner compartment of the central member, the direction of airflow can be simply changed by reversing the direction of the valve seat inside the first inner compartment of the central member. In this way, a tubular body equipped with the one-way valve assembly of the present invention can achieve the functions of an inflator and a suction device simply by reversing the direction of the valve seat. In addition, the non-return effect provided by the present invention is also enhanced compared with the conventional check valves, and the problems of unsmooth airflow and air leakage are also eliminated. The components of the one-way valve assembly needed for use with an inflator and suction device are the same. In addition, there is no need to add new components or change the shape or structure of the components for different application as well. Hence, the one-way valve assembly is adapted to be used with any inflators or suction devices, including small portable inflator and large floor type of inflator. The assembling process of the one-way valve assembly according to the present invention is simple, and therefore the production cost can be lowered.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an side section view showing an exploded one-way valve assembly according to a first embodiment of the present invention, wherein the one-way valve assembly is being used in an inflator;

FIG. 2 is a perspective section view showing the assembled one-way valve assembly according to the first embodiment of the present invention, wherein the one-way valve assembly is being used in the inflator;

FIG. 3A is a perspective and exploded view showing a valve seat and a valve plate of the one-way valve assembly of the present invention;

FIG. 3B is a perspective and section view showing the assembled valve seat and valve plate of the one-way valve assembly of the present invention;

FIG. 3C is a side section view showing the exploded valve seat and valve plate of the one-way valve assembly of the present invention;

FIG. 4A is a partial enlarged view showing a 4A portion of FIG. 2, wherein the one-way valve assembly according to the first embodiment is being used in the inflator, more particularly, FIG. 4A is a partial perspective and section view showing the movement of the valve plate when the inflator is being compressed for inflation;

FIG. 4B is a partial enlarged view showing the one-way valve assembly according to the first embodiment being used in the inflator, more particularly, FIG. 4B is a partial perspective and section view showing the movement of the valve plate when the one-way valve is preventing the back flow of the air;

FIG. 5 is a side section view showing an exploded one-way valve assembly according to a second embodiment of the present invention, wherein the one-way valve assembly is being used in a suction device;

FIG. 6 is a perspective and section view showing the assembled one-way valve assembly according to the second embodiment of the present invention, wherein the one-way valve assembly is being used in the suction device;

FIG. 7A is a partial enlarged view showing a 7A portion of FIG. 6, wherein the one-way valve assembly according to the second embodiment is being used in the suction device, more particularly, FIG. 7A is a partial perspective and section view showing the movement of the valve plate when the suction device is extracting air;

FIG. 7B is a partial enlarged view showing the one-way valve assembly according to the second embodiment being used in the suction device, more particularly, FIG. 7B is a partial perspective and section view showing the movement of the valve plate when the suction device is discharging air;

FIG. 8 is a side section view showing an exploded one-way valve assembly according to a third embodiment of the present invention, wherein the one-way valve is being used in an inflator;

FIG. 9 is a perspective and section view showing an assembled one-way valve assembly according to a third embodiment of the present invention, wherein the one-way valve is being used in the inflator;

FIG. 10A is a partial enlarged view showing a 10A portion of FIG. 9, wherein the one-way valve assembly according to the third embodiment is being used in the inflator, more particularly, FIG. 10A is a partial perspective and section view showing the movement of the valve plate when the inflator is being compressed for inflation;

FIG. 10B is a partial enlarged view showing the one-way valve assembly according to the third embodiment being used in the inflator, more particularly, FIG. 10B is a partial perspective and section view showing the movement of the valve plate when the one-way valve is preventing the back flow of the air;

FIG. 11 is a side section view showing an exploded one-way valve assembly according to a fourth embodiment of the present invention, wherein the one-way valve assembly is being used in a suction device;

FIG. 12 is a perspective and section view showing the assembled one-way valve assembly according to the fourth embodiment of the present invention, wherein the one-way valve assembly is being used in the suction device;

FIG. 13A is a partial enlarged view showing a 13A portion of FIG. 12, wherein the one-way valve assembly according to the fourth embodiment is being used in the suction device, more particularly, FIG. 13A is a partial perspective and section view showing the movement of the valve plate when the suction device is extracting air;

FIG. 13B is a partial enlarged view showing the one-way valve assembly according to the fourth embodiment being used in the suction device, more particularly, FIG. 13B is a partial perspective and section view showing the movement of the valve plate when the suction device is discharging air.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention. In the following descriptions, the direction to the left side of the drawings is referred to as a first direction, and the direction to the right side of the drawings are referred to as a second direction.

### First Embodiment

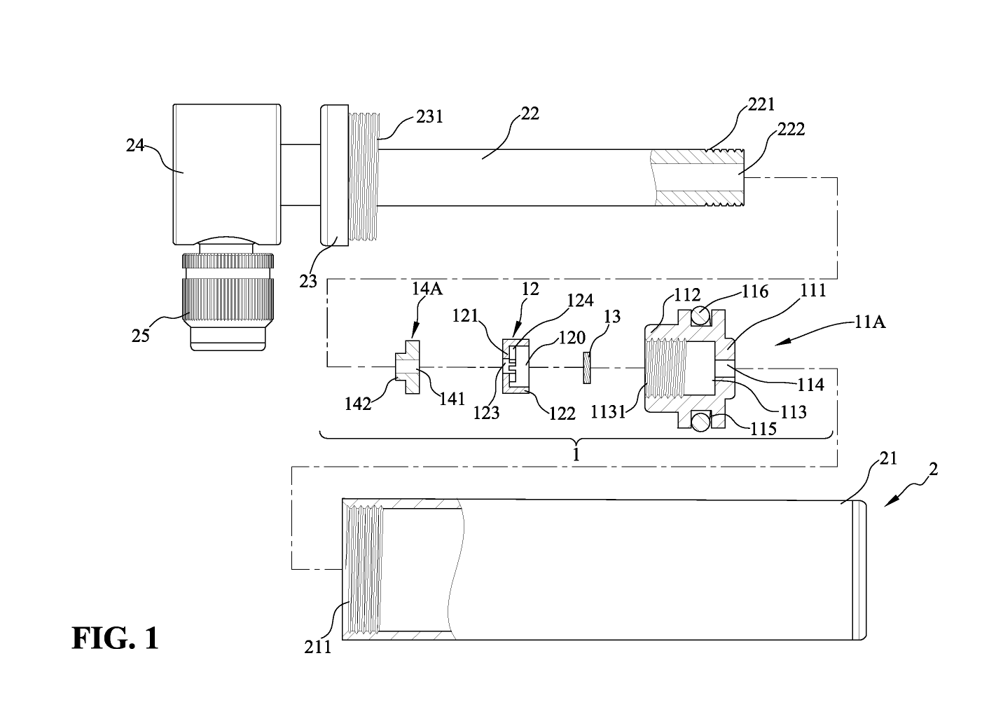

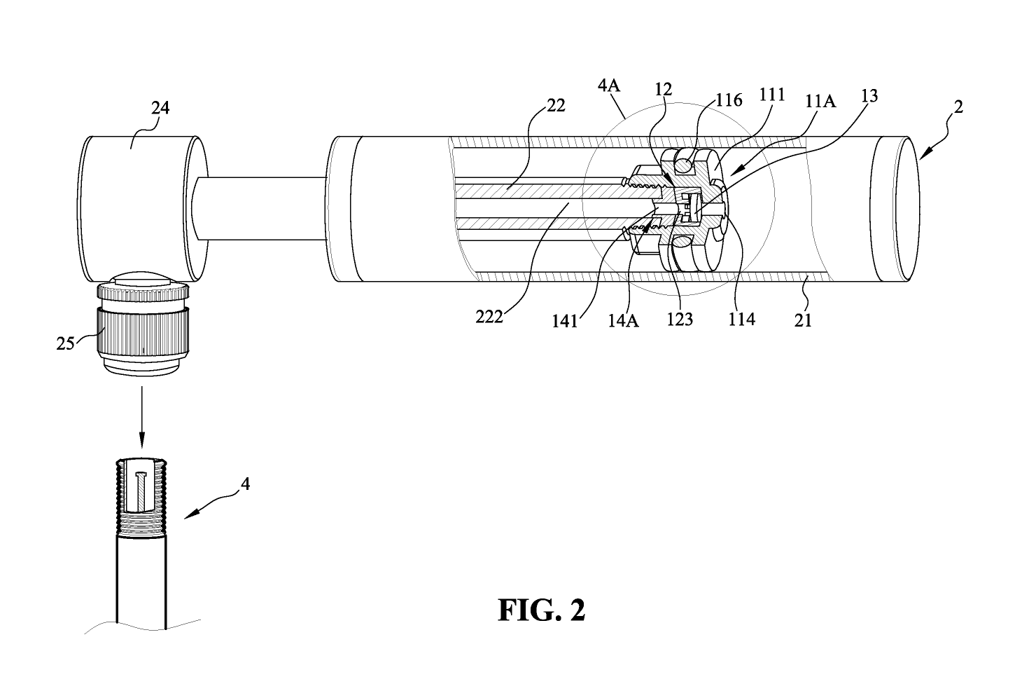

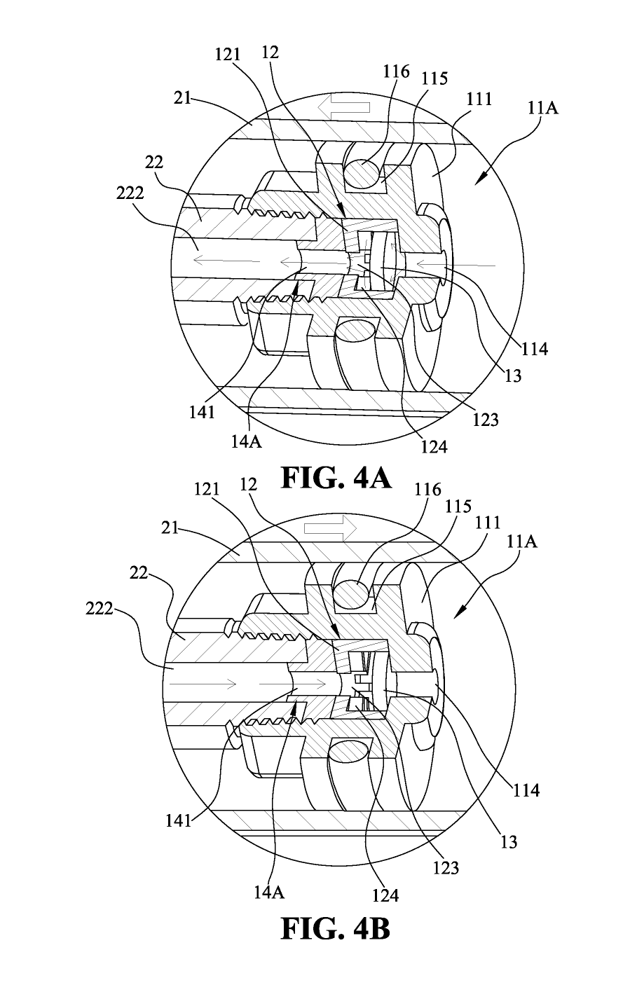

FIG. 1, FIG. 2, FIG. 4A and FIG. 4B are figures showing a first embodiment of the present invention, where the one-way valve assembly is adapted to be used in a small portable inflator 2. As shown in the figures, the one-way valve 1 includes a valve seat 12, a valve plate 13, a plug member 14A and a piston 11A. The piston 11A is used as a central member for receiving and assembling all the previous components. The inflator 2 includes a tubular body 21, a piston rod 22, a head member 24 for connecting the piston rod 22 and a cap 23, which is freely sleeved around the piston rod 22. A female thread 211 is disposed at the inner circumference of an end of the tubular body 21. The other end of the tubular body 21 is sealed. The piston rod 22 includes an air passage 222, which is axially in communication with the head member 24. The head member 24 further includes an air nozzle 25, which is in communication with the inner space of the head member. The air nozzle 25 can be connected with a nozzle 4 (as shown in FIG. 2) of an object to be inflated. A male thread 221 is disposed at the outer circumference of an end of the piston rod 22, opposite to the end of the head member 24. A male thread 231 is disposed at the cap 23. After the piston rod 22 passes through the cap 23, the male thread 221 is engaged with the female thread 1131 of the piston 11A. Subsequently, the piston rod 22 is inserted into the inner periphery of the tubular body 21, and the male thread 231 of the cap 23 is engaged with the female thread 211 of the tubular body 21. In this way, the piston rod 22 is able to move in a reciprocating manner in the axial direction relevant to the tubular body 21 inside thereof.

The components of the one-way valve 1 and the inflator 2 are axially assembled so as to form a complete inflator capable of outputting gas.

As shown in FIG. 1, in the one-way valve 1 assembly of the present invention, the piston 11A includes a first bottom portion 111. A first sidewall 112 is formed on the periphery of the first bottom portion 111 extending in a side of an axial direction thereof, and a first inner compartment 113 is formed by the first sidewall 112 together with the first bottom portion 111. In addition, a bottom surface of the first bottom portion 111 facing the first direction has to be a flat and complete surface. A first through hole 114 is disposed at the center of the first bottom portion 111. The first through hole 114 is configured to pass through the piston 11A from the first direction to the second direction. An annular groove 115 is disposed at the outer circumference of the piston 11A, and an O-ring 116 is disposed inside the annular grove 115. The external diameter of the O-ring 116 extends beyond the outer edge of the annular groove 115, in this way, when the piston 11A is assembled inside the inner periphery of the tubular body 21 of the inflator, the O-ring 116 and the internal wall of the tubular body 21 together creates an air-tight effect. A female thread 1131 is further disposed at the inner circumference of the first inner compartment 113 of the piston 11A near the opening.

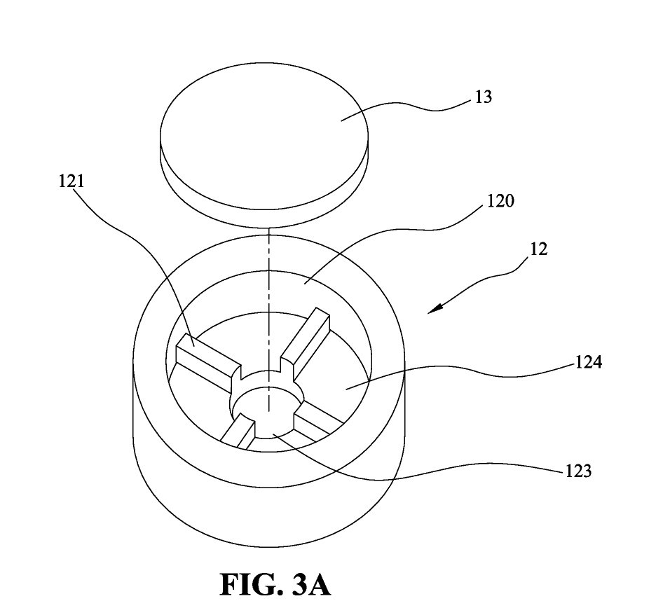

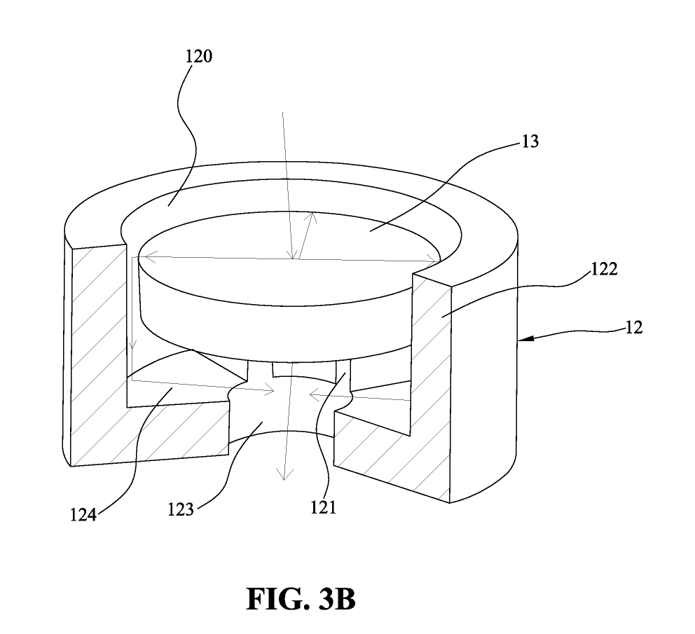

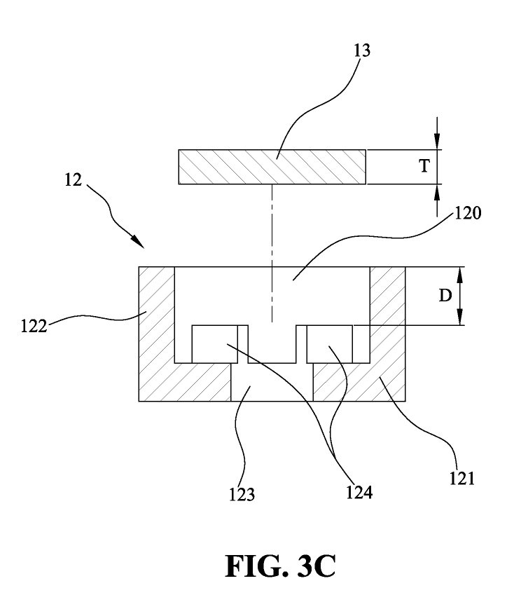

In the one-way valve 1, the valve seat 12 includes a second bottom portion 121. As shown in FIG. 1, a second sidewall 122 is formed on the periphery of the second bottom portion 121 extending in a side of an axial direction thereof, and a second inner compartment 120 having a depth D is formed by the second sidewall 122 together with the second bottom portion 121. A second through hole 123 is disposed at the second bottom portion 121 passing through the valve seat 12 from the first direction to the second direction. A plurality of recesses 124 is formed on a surface, which is originally flat and facing the second inner compartment 120, of the second bottom portion 121, so the second through hole 123 is spaced apart from the surface of the second bottom portion 121 with a distance. Meanwhile, the uneven structure formed by the recess 124 and the flat surface is able to strengthen the air transmitting ability of the second bottom portion 121. The valve seat 12 of the present invention is integrally formed, and can be manufactured from any suitable material. For example, if the valve seat is manufactured from metallic materials, then the recesses 124 can be formed by the process of milling or molding. If the valve seat 12 is manufactured from plastic materials, then the recesses 124 can be formed by the process of injection molding. As shown in FIG. 3A, according to a preferred embodiment of the present invention, the recesses 124 are arranged around the second through hole 124 with equal angular intervals in between. In this way, the airflow can pass through the second through hole 124 evenly, and the force is also evenly applied onto the valve seat 12 by the airflow.

The valve plate 13 of the one-way valve 1 is usually manufactured from elastic materials such as rubber or plastics. However, it can also be made from materials with better rigidity, such as metals, as long as the surfaces of the valve plate 13 are flat and smooth. Preferably, the outer contour of the valve plate 13 has a circular shape. The valve plate 13 has an outer diameter smaller than an inner diameter of the second inner compartment 120 of the valve seat 12 while larger than an inner diameter of the second through hole 123 and larger than an inner diameter of the first through hole 114. In addition, a thickness T of the valve plate is smaller than the depth D of the second inner compartment 120 (as shown in FIG. 3C). In the first embodiment of the present invention, the valve plate 13 is directly seated inside the second inner compartment 120 of the valve seat 12 first, then the valve seat 12 together with the valve plate 13 are seated inside the first inner compartment 113 with the opening of the second inner compartment 120 facing toward the piston 11A.

As shown in FIG. 1, the plug member 14A is provided with a third through hole 141, which passes through the plug member 14A in the axial direction thereof from the first direction to the second direction. A protrusion 142 with suitable length is disposed on the plug member 14A extending in the axial direction and in the first direction. The third through hole 141 passes through the center of the protrusion 142. An inner diameter of the third through hole 141 is smaller than the outer diameter of the valve plate 13. The outer diameter of the protrusion 142 is slightly larger than an inner diameter of the air passage 222 of the piston rod, so the protrusion 142 can be inserted into the air passage 22 from the end of the piston rod 22. In this way, the plug member 14A is fixed at the piston rod 22. Notably, the end surface of the plug member 14A facing the second direction has to be a flat and complete surface.

Herein, the assembling method of the abovementioned one-way valve 1 and inflator 2 will be described in details. First, the protrusion 142 of the plug member 14A is tightly fitted inside the air passage 222 at an end of the piston rod 22. Next, the valve plate 13 is seated inside the second inner compartment 120 of the valve seat 12 (as shown in FIG. 3B). Then, the valve plate 13 is seated inside the first inner compartment 113 of the piston 11A together with the valve plate 13. The male thread 221 of the piston rod 22 is engaged with the female thread 1131 of the piston 11A, so the plug member 14A is abutted against the valve seat 12 (as shown in FIG. 2). As a result, when the tubular body 21 and the piston rod 22 moves relevantly with each other in the axial direction, the piston 11A also moves in a reciprocating manner inside the tubular body 21.

As shown in FIG. 2, when the inflator 2 according to the first embodiment of the present invention is used to inflate an object, the air nozzle 25 of the head member 24 is connected with the nozzle 4 of the object to be inflated. Then, the user grabs the tubular body 21 and creates reciprocating movement between the first direction and the second direction in the axial direction thereof. As indicated by the arrows in FIG. 4A, when the tubular body 21 moves in the first direction, the piston 11A then moves relevantly in the second direction. At this point, the air inside the tubular body 21 on the right side of the piston 11A is pushed by the piston 11A and passes through the first through hole 114. After the air passes through the first through hole 114, the valve plate 13 is then pushed to abut against the second bottom portion 121 of the valve seat 12. However, due to the multiple recesses 124 on the surface of the second bottom portion 121 facing the second direction, there are still gaps existing between the periphery of the valve plate 13 and the inner circumference of the second inner compartment 120. As a result, the air is able to pass through the gaps and the recesses 124 to reach the second through hole 123 and the third through hole 141, and further passes through the air passage 222 and the air nozzle 25 of the head member 24 and enters the nozzle 4.

As indicated by the arrows in FIG. 4B, when the tubular body 21 moves toward the second direction, the piston 11A moves relevantly in the first direction. At this point, the air inside the air passage 222 of the piston rod 22 is pushed by the returning air and flows backward. The back flowing air then pushes the valve plate 13 to abut against the first bottom portion 111 of the piston 11A, and further seals the first through hole 114 completely. In this way, the air is prevented from flowing backward. Through the reciprocating motion described above, the inflator is able to inflate the object.

### Second Embodiment

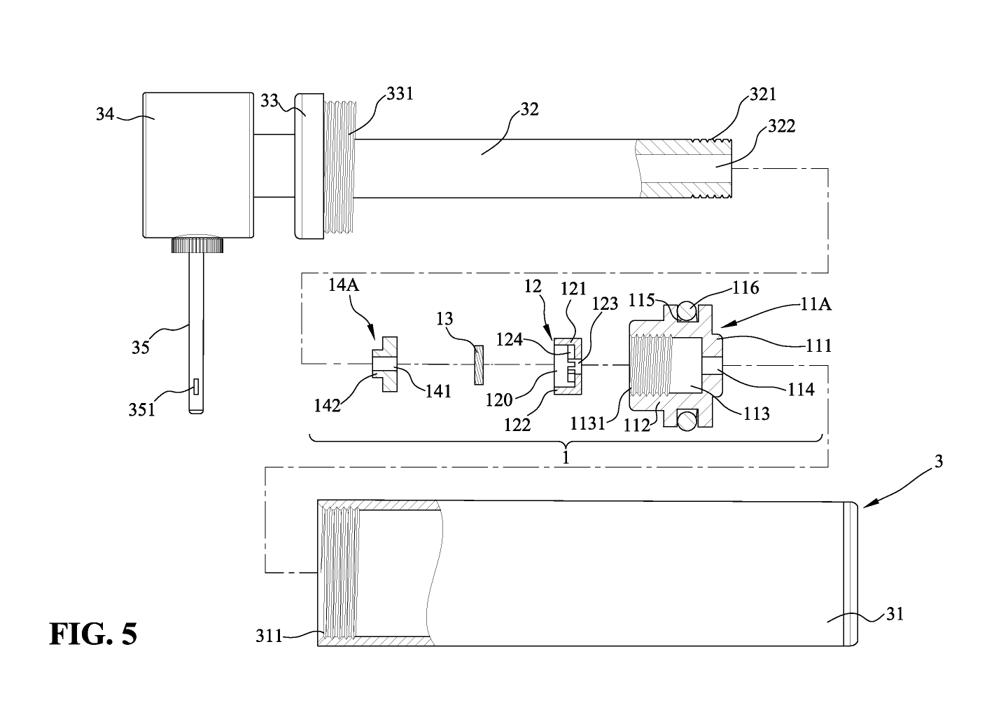

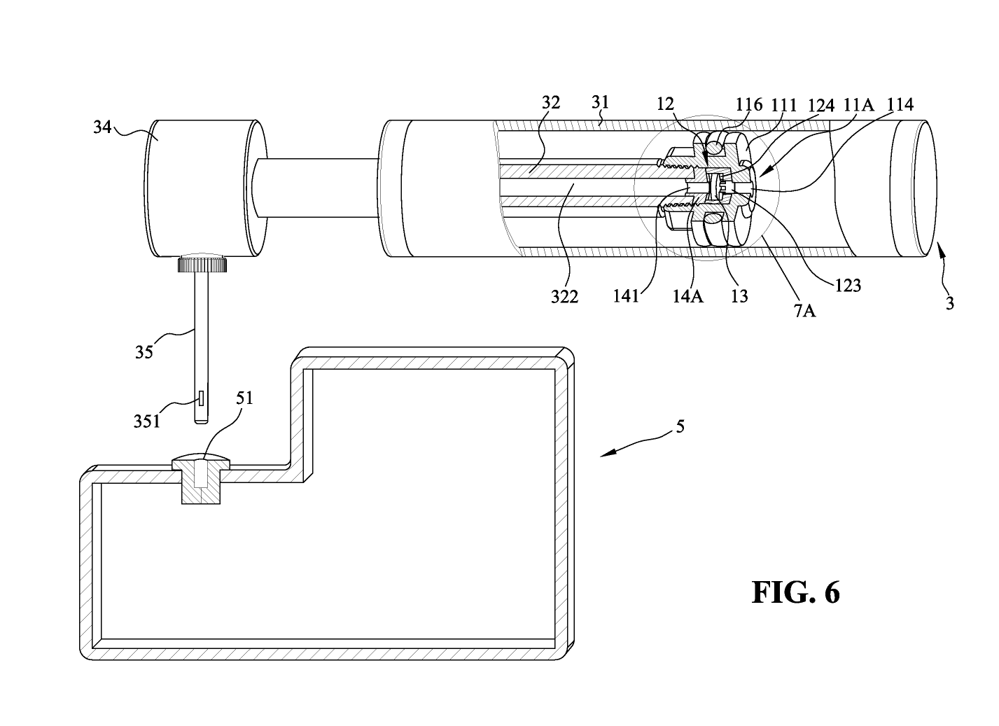

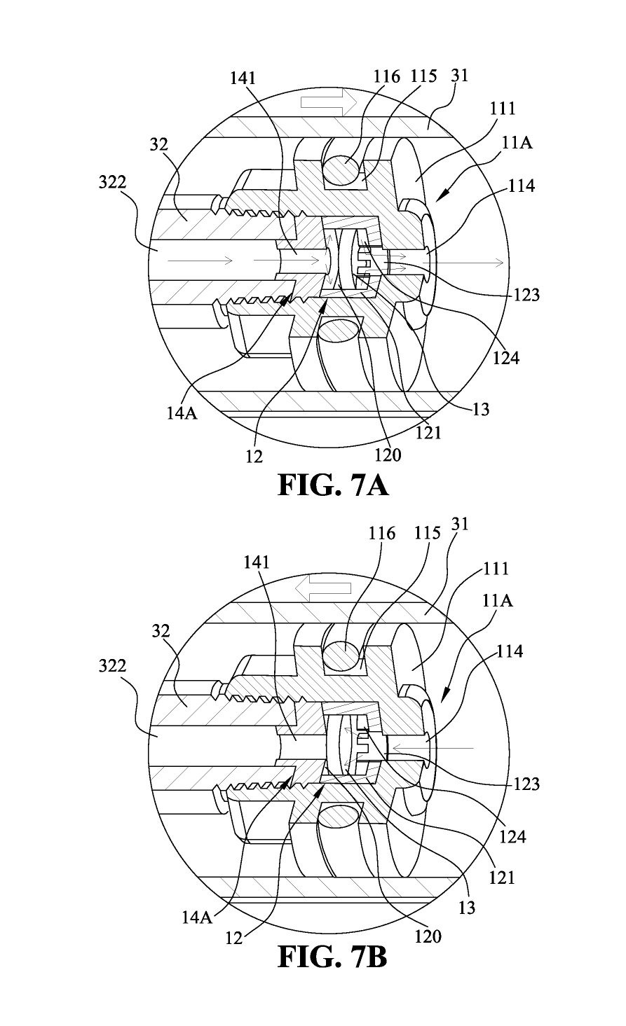

FIG. 5, FIG. 6, FIG. 7 A and FIG. 7B are figures showing a second embodiment of the present invention, where the one-way valve assembly is adapted to be used in a suction device 3. The structure of the one-way valve 1 according to the second embodiment is completely the same as the one-way valve 1 according to the first embodiment. The one-way valves 1 according to both embodiments both include a valve seat 12, a valve plate 13, a plug member 14A and a piston 11A. The piston 11A in the second embodiment is also used as a central member for receiving and assembling all the previous components. Hence, in order to avoid redundancies, the structure of the one-way valve 1 will not be explained again in the second embodiment. The structure of the suction device 3 is similar to the inflator 2 described in the first embodiment. The difference between the suction device 3 and the inflator 2 is that the air nozzle 25 in the inflator 2 is replaced with an air needle 35 at the head member 34 of the suction device 3. To be more precise, the suction device 3 includes a tubular body 31, a piston rod 32, a head member 34 connecting the piston rod 32, and a cap 33 freely sleeved around the piston rod 32. A female thread 311 is disposed at the inner circumference of an end of the tubular body 21. The other end of the tubular body 31 is sealed. The piston rod 32 includes an air passage 322, which is axially in communication with the head member 34. The head member 34 further includes an air needle 35, which is in communication with the inner space of the head member 34. A pinhole 351 allowing airflow is disposed at a sidewall and near the end of the air needle 35. A male thread 321 is disposed at the outer circumference of an end of the piston rod 32, opposite to the end of the head member 34. A male thread 331 is disposed at the cap 33. After the piston rod 32 passes through the cap 33, the male thread 321 is engaged with the female thread 1131 of the piston 11A. Subsequently, the piston rod 32 is inserted into the inner periphery of the tubular body 31, and the male thread 331 of the cap 33 is engaged with the female thread 311 of the tubular body 31. In this way, the piston rod 32 is able to move in a reciprocating manner in the axial direction relevant to the tubular body 31 inside the tubular body 31.

The purpose of the suction device 3 is to vacuum the air from a vacuum container 5. Therefore, the operation method and principle of the suction device 3 is opposite to the inflator described in the first embodiment. When using the one-way valve 1 provided by the present invention in the suction device 3, the user can simply reverse the installing direction of the valve seat 12 so it is opposite to the direction of the valve seat 12 in the inflator. After the direction of the valve seat 12 is reversed, it is placed into the first inner compartment 113 of the piston 11A. In this way, the suction device 3 can function accordingly. Comparing FIG. 5 with FIG. 1, it can be seen that the valve seat 12 in the second embodiment is reversed by 180 degrees so that the second sidewall 122 is extending in the first direction. In other words, the second inner compartment 120 and the recesses 124 are facing in the first direction. The valve plate 13 is seated into the second inner compartment 120 from the first direction.

Herein, the assembling method of the abovementioned one-way valve 1 and suction device 3 will be described in details. First, the protrusion 142 of the plug member 14A is tightly fitted inside the air passage 322 at an end of the piston rod 32. Next, the valve plate 13 is seated inside the second inner compartment 120 of the valve seat 12. Then, the valve plate 13 is seated inside the first inner compartment 113 of the piston 11A together with the valve plate 13, so the second inner compartment 120 and the first inner compartment 113 are facing in the first direction. The male thread 321 of the piston rod 32 is engaged with the female thread 1131 of the piston 11A, so the plug member 14A is abutted against the opening of the second inner compartment of the valve seat 12. As a result, when the tubular body 31 and the piston rod 22 moves relevantly with each other in the axial direction, the piston 11A also moves in a reciprocating manner inside the tubular body 21.

As shown in FIG. 6, when the suction device 3 according to the second embodiment of the present invention is used to vacuum the vacuum container 5, the air needle 35 is inserted into the flexible valve 51 of the vacuum container 5. Then, the user grabs the tubular body 31 and creates reciprocating movement between the first direction and the second direction in the axial direction thereof. As indicated by the arrows in FIG. 7A, when the tubular body 31 moves in the second direction, the piston 11A then moves relevantly in the first direction. At this point, vacuum effect is created inside the tubular body 21 on the right side of the piston 11A, causing the air inside the vacuum container 5 to be vacuumed through the air needle 35, air passage 322 and the third through hole 141 of the piston 14A into the second inner compartment 120. The vacuumed air then pushes the valve plate 13 to abut against the second bottom portion 121 of the valve seat 12. However, due to the multiple recesses 124 on the surface of the second bottom portion 121 facing the first direction, there are still gaps existing between the periphery of the valve plate 13 and the inner circumference of the second inner compartment 120 of the valve seat. As a result, the air is able to pass through the gaps and the recesses 124 to reach the second through hole 123 and the first through hole 114, and then enters the tubular body 31.

As indicated by the arrows in FIG. 7B, when the tubular body 31 moves toward the first direction, the piston 11A moves relevantly in the second direction. At this point, the air inside the air passage 322 is compressed. The compressed air then pushes the valve plate 13 to abut against the plug member 14A, and further seals the third through hole 141 completely. In this way, the compressed air is discharged from the discharge hole disposed inside the tubular body 31. Through the reciprocating motion described above, the suction device is able to conduct air suction.

### Third Embodiment

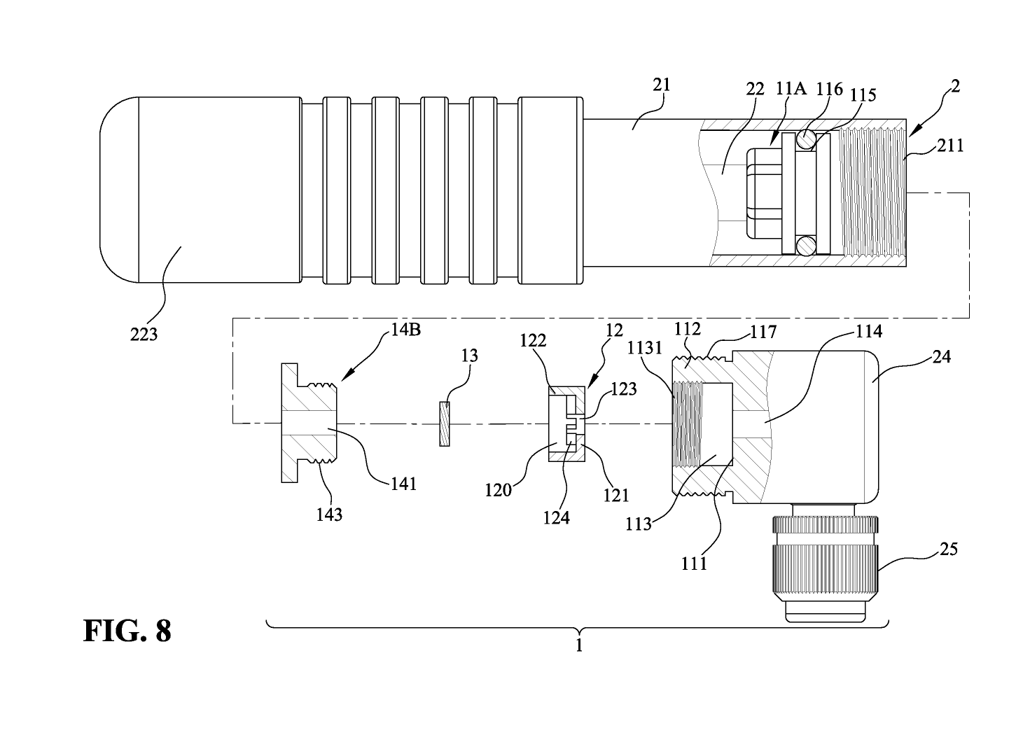

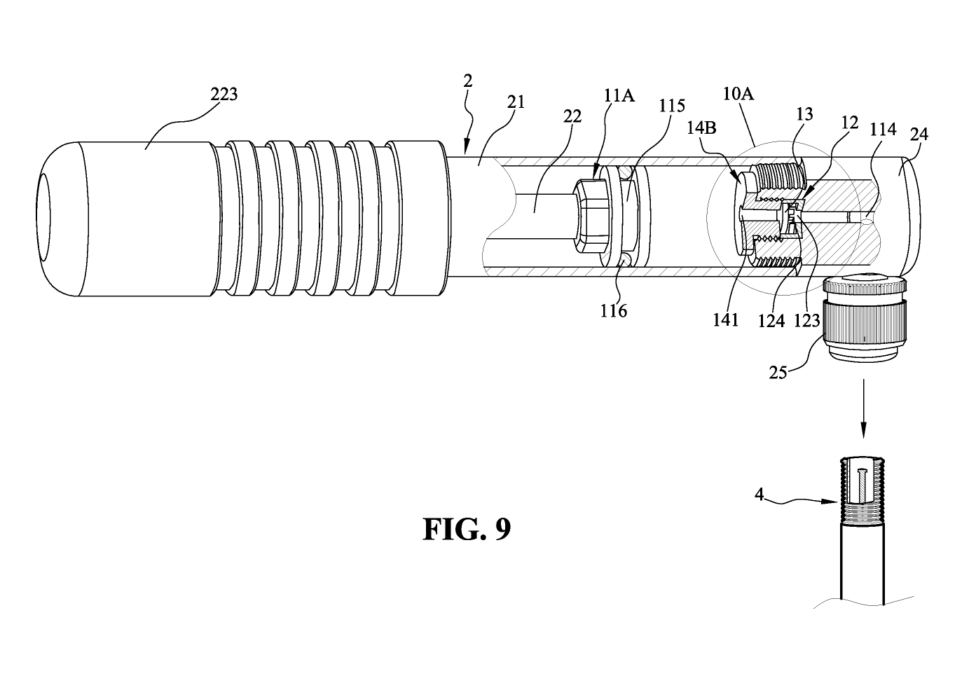

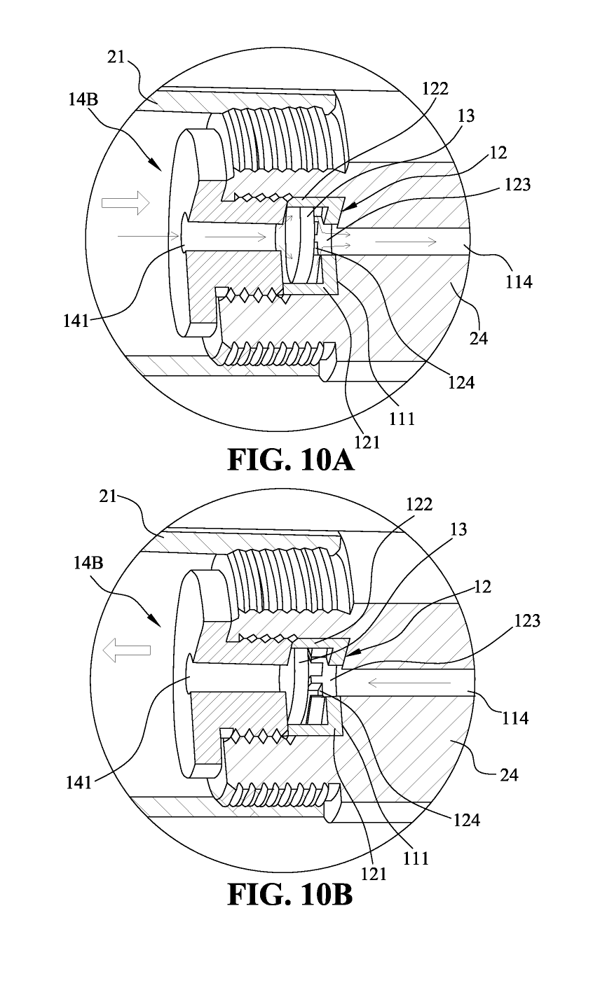

FIG. 8, FIG. 9, FIG. 10A and FIG. 10B are figures showing a third embodiment of the present invention, where the one-way valve assembly is adapted to be used in another type of small portable inflator 2. As shown in the figures, the one-way valve 1 includes a valve seat 12, a valve plate 13, a plug member 14B and a head member 24, which also belongs to a part of the inflator 2. The inflator 2 includes a tubular body 21, a piston rod 22, a piston 11A for connecting the piston rod 22, and a head member 24 as mentioned above. A female thread 211 is disposed at an end of the tubular body 21 in the inner circumference thereof for engaging with the head member 24. The piston rod 22 passes through and extends beyond the other end of the tubular body 21, and a handle 223 is disposed at the part of piston rod 22 extending beyond the tubular body 21. In this way, when a user grabs the handle 223 to operate the piston rod 22 and create reciprocating motion in relevant to the tubular body 21, the piston 11A also moves in a reciprocating manner inside the tubular body 21 correspondingly.

The components of the one-way valve 1 and the inflator 2 are axially assembled so as to form a complete inflator capable of outputting gas.

In the one-way valve 1 assembly of the present invention, the head member 24 includes a first bottom portion 111. A first sidewall 112 with suitable length is formed on the periphery of the first bottom portion 111 extending in a side of an axial direction thereof, and a first inner compartment 113 is formed by the first sidewall 112 together with the first bottom portion 111. A first through hole 114 connecting the air nozzle 25 is disposed at the center of the first bottom portion 111. In addition, a female thread 1131 is disposed at the inner circumference of the first inner compartment 113 of the head member 24 near the opening, and a male thread 117 is disposed at the outer circumference of the head member 24. The male thread 117 can be engaged with the female thread 211 of the tubular body 21, so as to assemble the head member 24 with the tubular body 21.

As described in the first embodiment, the valve seat 12 of the one-way valve 1 includes a second bottom portion 121. As shown in FIG. 8, a second sidewall 122 with suitable length is formed on the periphery of the second bottom portion 121 extending in a side of an axial direction thereof, and a second inner compartment 120 is formed by the second sidewall 122 together with the second bottom portion 121. At least one second through hole 123 is disposed at the second bottom portion 121 passing through the valve seat 12 from the first direction to the second direction. A plurality of recesses 124 is formed on a surface, which is facing in the first direction, of the second bottom portion 121, so the second through hole 123 is spaced apart from the surface of the second bottom portion 121 with a distance.

The valve plate 13 of the one-way valve 1 is usually manufactured from elastic materials such as rubber or plastics. However, it can also be made from materials with better rigidity, such as metals, as long as the surfaces of the valve plate 13 are flat and smooth. Preferably, the outer contour of the valve plate 13 should have a circular shape. The valve plate 13 has an outer diameter slightly smaller than an inner diameter of the second inner compartment 120 of the valve seat 12 while larger than an inner diameter of the second through hole 123. In addition, a thickness T of the valve plate 13 is smaller than a depth D of the second inner compartment 120 of the valve seat 12. In the third embodiment of the present invention, first, the valve plate 13 is directly seated inside the second inner compartment 120 of the valve seat 12, then the valve seat 12 together with the valve plate 13 are seated inside the first inner compartment 113 of the head member 24 with the second direction of the valve seat 12 facing toward the head member 24. In this way, the first inner compartment 113 of the head member 24 and the second inner compartment 120 of the valve seat 12 are both facing in the first direction.

The plug member 14B of the one-way valve 1 includes a third through hole 141, which passes through the plug member 14B axially from the first direction to the second direction. A male thread 143 is disposed at the outer circumference of the plug member 14B. An inner diameter of the third through hole is smaller than the outer diameter of the valve plate 13. The surface of the plug member 14B facing the second direction has to be a flat and complete surface.

Herein, the assembling method of the abovementioned one-way valve 1 and inflator 2 will be described in details. First, the valve plate 13 is seated inside the second inner compartment 120 of the valve seat 12. Next, the valve plate 13 is seated inside the first inner compartment 120 of the head member 24 together with the valve plate 13. Then, the male thread 143 of the plug member 14B is engaged with the female thread 1131 of the head member 24. As a result, the plug member 14B is abutted against the valve seat 12.

As shown in FIG. 9, when the inflator 2 according to the third embodiment of the present invention is used to inflate an object, the air nozzle 25 of the head member 24 is connected with the nozzle 4 of the object to be inflated. Then, the user grabs the handle 223 to operate the piston rod 22 and the piston 11A to create reciprocating movement between the first direction and the second direction in the axial direction thereof. As indicated by the arrows in FIG. 10A, when the piston 11A moves in the second direction, the air is pushed by the piston 11A and passes through the third through hole 141, and further pushes the valve plate 13 to abut against the second bottom portion 121 of the valve seat 12. However, due to the multiple recesses 124 on the surface facing the first direction of the second bottom portion 121, there are still gaps existing between the periphery of the valve plate 13 and the inner circumference of the second inner compartment 120. As a result, the air is able to pass through the gaps and the recesses 124 to reach the second through hole 123 and the first through hole 114, and further passes through the air nozzle 25 of the head member 24 and enters the nozzle 4 of the object to be inflated.

As indicated by the arrows in FIG. 10B, when the piston 11A moves in the first direction, vacuum effect is generated inside the tubular body 21 between the piston 11A and the plug member 14B. In this way, the air inside the head member 24 is pushed by the returning air and flows backward. The back flowing air then pushes the valve plate 13 to abut against the plug member 14B via the second through hole 123 of the valve seat 12, and further seals the third through hole 141 completely. In this way, the air is prevented from flowing backward. Through the reciprocating motion described above, the inflator is able to inflate the object. Fourth Embodiment

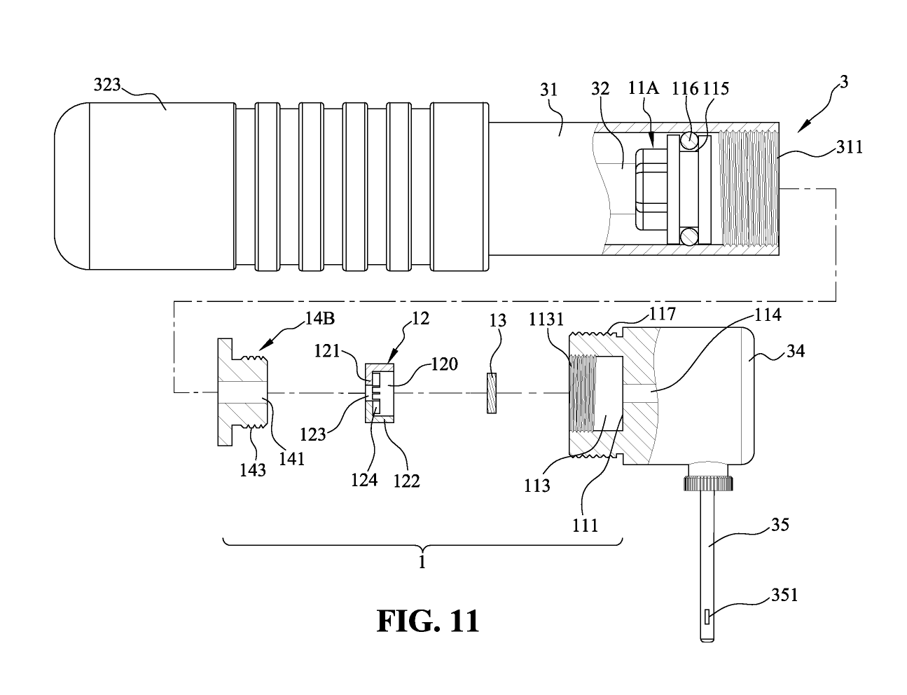

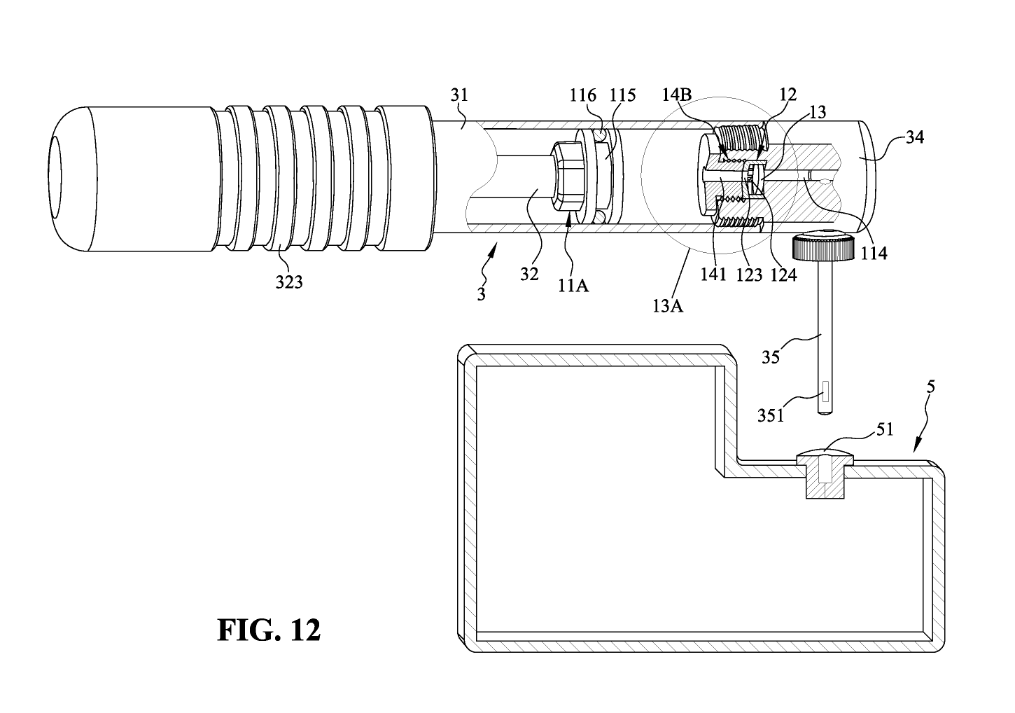

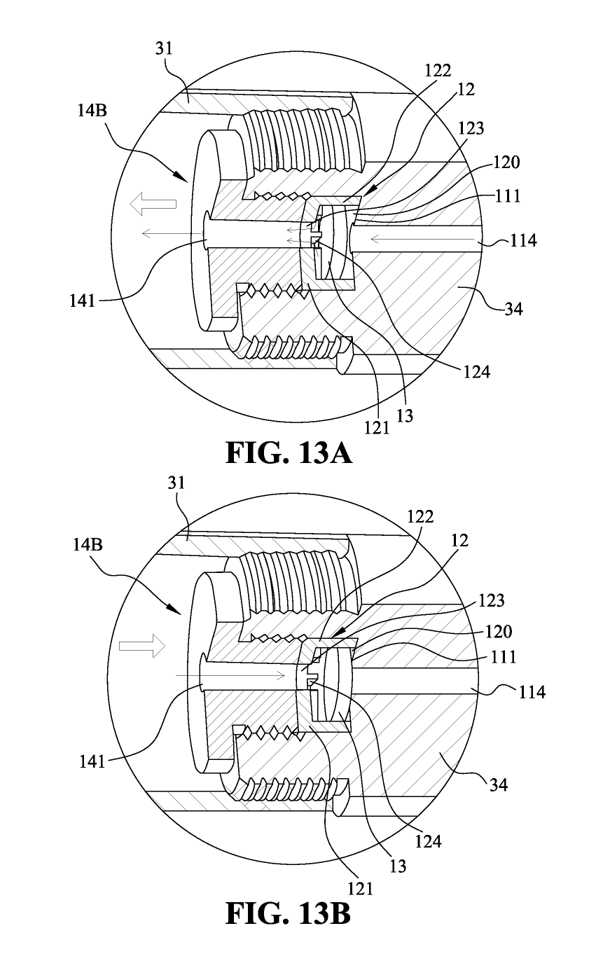

FIG. 11, FIG. 12, FIG. 13A and FIG. 13B are figures showing a fourth embodiment of the present invention, where the one-way valve assembly is adapted to be used in a suction device 3. The structure of the one-way valve 1 according to the fourth embodiment is completely the same as the one-way valve 1 described in the third embodiment. The one-way valves 1 according to both embodiments both include a valve seat 12, a valve plate 14, a plug member 14B and a head member 34. The head member 34 in the fourth embodiment is also used for receiving and assembling all the previous components. Hence, in order to avoid redundancies, the structure of the one-way valve 1 will not be explained again in the fourth embodiment. The structure of the suction device 3 is similar to the inflator 2 described in the third embodiment. The difference between the suction device 3 and the inflator 2 is that the air nozzle 25 in the inflator 2 is replaced with an air needle 35 at the head member 34 in the suction device 3. To be more precise, the suction device 3 includes a tubular body 31, a piston rod 32, and a piston 11A connecting the piston rod 32. A female thread 311 is disposed at an end of the tubular body 21 in the inner circumference thereof for engaging with the head member 34. The piston rod 32 passes through and extends beyond the other end of the tubular body 31, and a handle 323 is disposed at the part of piston rod 32 extending beyond the tubular body 31. In this way, when a user grabs the handle 323 to operate the piston rod 32 and create reciprocating motion in relevant to the tubular body 31, the piston 11A also moves in a reciprocating manner inside the tubular body 31 correspondingly.

The purpose of the suction device 3 is to vacuum the air from a vacuum container 5. Therefore, the operation method and principle of the suction device 3 is opposite to the inflator described in the third embodiment. When using the one-way valve 1 provided by the present invention in the suction device 3, the user can simply reverse the installing direction of the valve seat 12 so it is opposite to the direction of the valve seat 12 in the inflator. After the direction of the valve seat 12 is reversed, it is placed into the first inner compartment 113 of the head member 34. In this way, the suction device 3 can function accordingly. Comparing FIG. 11 with FIG. 8, it can be seen that in the fourth embodiment, the valve seat 12 is reversed by 180 degrees so that the second sidewall 122 is extending in the second direction. In other words, the second inner compartment 120 and the recesses 124 are facing in the second direction. The valve plate 13 is seated into the second inner compartment 120 from the second direction. After the valve plate 13 is seated into the second inner compartment 120 of the valve seat 12, the valve plate 13 together with the valve seat 12 are seated inside the first inner compartment 113 of the head member 34. Subsequently, the male thread 143 of the plug member 14B is engaged with the female thread 1131 of the first inner compartment so the valve seat 12 is abutted. As a result, when the tubular body 31 and the piston rod 32 move relevantly with each other in the axial direction thereof, the piston 11A also moves in a reciprocating manner inside the tubular body 31.

As shown in FIG. 12, when the suction device 3 according to the fourth embodiment of the present invention is used to vacuum the vacuum container 5, the air needle 35 is inserted into the flexible valve 51 of the vacuum container 5. Then, the user grabs the handle 323 and creates reciprocating movement between the first direction and the second direction in the axial direction thereof. As indicated by the arrows in FIG. 13A, when the handle 323 moves in the first direction, vacuum effect is created inside the tubular body 31 between the piston 11A and the plug member 14B, causing the air inside the vacuum container 5 to be vacuumed into the first through hole 114 via the air needle 35. The vacuumed air then pushes the valve plate 13 to abut against the second bottom portion 121 of the valve seat 12. However, due to the multiple recesses 124 on the surface of the second bottom portion 121 facing the second direction, there are still gaps existing between the periphery of the valve plate 13 and the inner circumference of the second inner compartment 120 of the valve seat. As a result, the air is able to pass through the gaps and the recesses 124 to reach the second through hole 123 and the third through hole 141, and then enters the tubular body 31.

As indicated by the arrows in FIG. 13B, when the handle 323 moves toward the second direction, the piston 11A moves in the second direction simultaneously. At this point, the air inside the tubular body 31 is compressed. The compressed air then pushes the valve plate 13 to abut against the first bottom portion 111 of the head member 34, and further seals the first through hole 114 completely. In this way, the compressed air is discharged from the discharge hole (not shown) disposed inside the tubular body 31. Through the reciprocating motion described above, the suction device is able to conduct air suction.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A one-way valve assembly, comprising:
a central member having a first bottom portion, wherein a first sidewall is formed on the periphery of the first bottom portion extending in a side of an axial direction thereof, and a first inner compartment is formed by the first sidewall together with the first bottom portion; wherein at least one first through hole is disposed through the first bottom portion;
a valve seat having a second bottom portion, wherein a second sidewall is formed on the periphery of the second bottom portion extending in a side of an axial direction thereof, and a second inner compartment is formed by the second sidewall together with the second bottom portion; wherein at least one second through hole is disposed through the second bottom portion; wherein a plurality of recesses is formed on a surface, which is facing the second inner compartment, of the second bottom portion, so the second through hole is spaced apart from the surface of the second bottom portion with a distance; wherein the valve seat is seated in the first compartment of the central member;
a valve plate having an outer diameter smaller than an inner diameter of the second inner compartment of the valve seat while larger than an inner diameter of the second through hole, and having a thickness smaller than a depth of the second inner compartment; wherein the valve plate is seated in the second compartment of the valve seat; and
a plug member having a third through hole, wherein the plug member is seated in the first inner compartment in such way that the valve seat and the valve plate are restricted in the first inner compartment between the first bottom portion and the plug member.

2. The one-way valve assembly according to claim 1, wherein the central member is a type of piston.

3. The one-way valve assembly according to claim 1, wherein the central member is a component of an inflator or a suction device.

4. The one-way valve assembly according to claim 2, wherein a female thread is disposed in the first inner compartment of the central member for engaging with a male thread disposed at a piston rod.

5. The one-way valve assembly according to claim 3, wherein a female thread is disposed in the first inner compartment of the central member for engaging with a male thread disposed at the plug member.
